(19) United States
(12) Patent Application Publication
(10) Pub. No.: US 2025/0286406 A1
(43) Pub. Date: Sep. 11, 2025

(54) METHOD FOR SETTING AN OPERATING PARAMETER OF A DEVICE FOR INDUCTIVE TRANSMISSION OF ELECTRICAL POWER, AND DEVICE

(71) Applicant: Turck Holding GmbH, Halver (DE)

(72) Inventors: Christian Seliger, Lauter-Bernsbach (DE); Tobias Gerz, Schwarzenberg (DE)

(73) Assignee: Turck Holding GmbH, Halver (DE)

(21) Appl. No.: 19/068,350

(22) Filed: Mar. 3, 2025

(30) Foreign Application Priority Data
Mar. 6, 2024 (DE) 10 2024 106 409.9

(51) Int. Cl. H02J 50/12

(52) U.S. Cl. CPC H02J 50/12

(57) ABSTRACT

A method for setting at least one operating parameter of a device for inductive transmission of electrical power, the method comprising operating at least one oscillating circuit of the device with a measurement activation frequency; wherein the measurement activation frequency is varied over a specified measuring range in such a way that a series of measurements is acquired, wherein the measurement series relates to at least one operating measured value as a function of the measurement activation frequency; determining a device parameter as a function of the measurement series; and determining and setting the operating parameter depending on the determined device parameter; wherein the operating parameter relates to at least one threshold value for a start and/or ending of the inductive power transmission and/or at least one threshold value for foreign object detection in the inductive power transmission.

### CROSS REFERENCE TO RELATED APPLICATION

This application claims priority to German patent application 10 2024 106 409.9 filed on Mar. 6, 2024, which is hereby incorporated by reference in its entirety.

### TECHNICAL FIELD

The disclosure relates to a method for setting at least one operating parameter of a device for inductive transmission of electrical power and to a device for inductive transmission of electrical power.

### BACKGROUND

The disclosure is in the field of inductive couplers, which allow a contactless transmission of electrical power. The efficiency of inductive power transmission between inductively coupled systems depends, among other things, on how exactly the oscillating circuits of the primary side (primary oscillating circuit, transmitter) and the secondary side (secondary oscillating circuit, receiver) are matched to each other for energy transmission.

However, the components of the primary and secondary oscillating circuits are subject to production-related tolerances, which in turn has an effect on the functionality of the power transmission and optionally the amount of power losses during transmission. The influence of component tolerances can therefore adversely affect the efficiency of the transferable energy from the primary to the secondary side.

A particular difficulty can be the fact that the electrical components are typically encapsulated so that they cannot be modified or replaced at will.

Document WO 2009/089253 A1 discloses an inductive power supply with duty cycle control. In this case, a memory may be provided in which specific resonance frequencies for various secondary devices as well as further information, such as a maximum and a minimum operating frequency, are stored.

EP 2 690 739 A2 describes a circuit for inductive power transmission. In this case, a primary unit comprises a resonance network and a primary circuit which have a first and second resonance frequency respectively. The circuit is then operated with a driver signal, the frequency of which lies between the first and second resonance frequencies.

### SUMMARY

A method for setting at least one operating parameter of a device for inductive transmission of electrical power is provided. The method comprises operating at least one oscillating circuit of the device with a measurement activation frequency, wherein the measurement activation frequency is varied over a specified measuring range in such a way that a series of measurements is acquired, wherein the measurement series relates to at least one operating measured value as a function of the measurement activation frequency. The method comprises determining a device parameter as a function of the measurement series. The method comprises determining and setting the operating parameter depending on the determined device parameter, wherein the operating parameter relates to at least one threshold value for a start and/or ending of the inductive power transmission and/or at least one threshold value for foreign object detection in the inductive power transmission.

A device for inductive transmission of electrical power is provided. The device comprises an oscillating circuit and a control unit. The control unit is configured to activate the device in such a way that the oscillating circuit is operated with a measurement activation frequency, wherein the measurement activation frequency is varied over a specified measuring range, a series of measurements with an operating measurement value as a function of the measurement activation frequency is recorded, a device parameter is determined as a function of the measurement series, and at least one operating parameter of the device is determined and set depending on the determined device parameter, wherein the operating parameter relates to at least one threshold value for a start and/or ending of the inductive power transmission and/or at least one threshold value for foreign object detection in the inductive power transmission.

### BRIEF DESCRIPTION OF THE DRAWINGS

In the drawings:

FIG. 1 shows a schematic drawing of a primary and a secondary oscillating circuit;

FIG. 2 shows a diagram showing the sequence of a program for ,,teaching” the operating parameter;

FIGS. 3A and 3B show an equivalent circuit diagram and simulated measurement data for an uncoupled primary device;

FIGS. 4A and 4B show an equivalent circuit diagram and simulated measurement data for an unknown primary device which is coupled to a known secondary device; and

FIGS. 5A and 5B show an equivalent circuit diagram and simulated measurement data for a known primary device which is coupled to an unknown secondary device.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A method for setting at least one operating parameter of a device for inductive, optionally contactless, transmission of electrical power may be provided, in which at least one oscillating circuit of the device may be operated with a measurement activation frequency. The measurement activation frequency may be varied over a specified measuring range in such a way that a series of measurements is recorded, wherein the measurement series relates to at least one operating measurement value according to the measurement activation frequency. For example, the measurement activation frequency can be changed in predetermined steps and a series of different measurement activation frequencies can be set in succession for a predetermined duration. Depending on the measurement series, optionally by an evaluation of the measurement series, a device parameter may be determined, and the operating parameter may be determined and set depending on the determined device parameter.

A measurement activation frequency can be optionally a primary activation frequency with which the primary oscillating circuit is excited. Optionally, the measurement activation frequency is not separately measured; instead, a microcontroller can output this as an adjustable frequency.

In order to record the measurement series, the measurement activation frequency can be varied in predefined steps, for example by incrementing from a minimum to a maximum frequency of the measurement range. The measurement activation frequency can be set for a predetermined duration at each step, so that effects during the transient behavior of the oscillating circuit can be avoided.

The device parameters can then be determined by evaluating the measurement series. For example, local and/or global extremes of the measurement series can be determined. The physical properties of the device and optionally of the primary oscillating circuit can be characterized in this way, optionally by means of the device parameter. For example, a resonant frequency of the primary oscillating circuit can be determined. The operating parameter can then be set as a function of this value.

The disclosure allows, for example, for the device for inductive power transmission to be operated in such a way that parameters for power transmission are set, for example, in the firmware in order to optimize the power transmission. In known systems, however, components of the primary and secondary oscillating circuit are typically designed in such a way that they enable a greater power level and can thus, if necessary, compensate for fluctuations due to manufacturing tolerances. The disclosure therefore permits an extended range of possible applications in order to cope with various limitations or additions in the end application.

For example, a maximum transmissible power or a transmission distance between the primary and secondary sides can be configured. Additional firmware versions can be offered to adjust the range of functionality of the device.

The operating parameter can be set optionally as part of the process of producing the device. The operating parameter for the uncoupled primary device or for a system of coupled primary and secondary devices can be determined and the operating parameter can be stored, for example, in a firmware as a parameter of the individual device. The operating parameter can therefore be determined and permanently stored for a primary device itself or for a specific combination of primary and secondary devices.

The operating parameter can also be set while the device is in use in the end application. Optionally, the operating parameter of the primary device is set in an uncoupled state, that is, without simultaneous inductive transmission of power to a secondary device. By determining the operating parameter directly during the application, possible environmental influences on the functionality of the primary side can be taken into account, for example depending on a particular installation situation or interference effects caused by adjacent devices. In a further step, the properties of a secondary device can be determined in a coupled state with the now known primary side. Application-specific influences for system optimization are also taken into account in the process. The operating parameter can then be optimized for the coupled system.

In one configuration of the method, the device is designed as a primary device, which can be operated as a transmitter for inductive power transmission. Optionally, the primary device can be operated in an uncoupled state. An uncoupled state is characterized optionally in that the primary device is not coupled to a secondary device for inductive power transmission.

In a further configuration, the device may be designed as a primary device which is coupled to a secondary device.

In a further configuration, the device may be designed as a system with a primary device and a secondary device, which can be operated as a transmitter and receiver for inductive power transmission.

Optionally, the primary device and the secondary device of a system can be operated in either an uncoupled state or in a state where they are coupled to the inductive power output.

In a further configuration the oscillating circuit of the device is designed as the primary oscillating circuit of the primary device. The oscillating circuit can optionally be operated in an uncoupled state or in a coupled state.

In a further development of the disclosure, the operating parameter may relate to an operating frequency for an inductive power transmission, optionally an activation frequency for operating the primary oscillating circuit, for example, a starting frequency for the power transmission to an inductively coupled secondary side. The operating parameter may also relate to a minimum activation frequency, which is usually at least 100 kHz, for example 105 kHz, and below which the system would be operated at an unfavorable operating point or efficiency during the inductive power transmission. The operating parameter may further relate to at least one threshold value for starting and/or ending the inductive power transmission, for example threshold values of the induced secondary voltage for enabling or terminating a power transmission from the primary to the secondary side or for enabling the supply of power to a consumer connected on the secondary side. It may also relate to at least one threshold value for a foreign object detection (FOD) during the inductive power transmission. As a result, particularly relevant parameters for the operation of the inductive coupler are advantageously adapted.

In one configuration, the operating measurement value is an electrical operating measurement value, which relates, for example, to a primary input current strength of a primary device of an inductive coupler and/or a secondary output voltage of a secondary device of an inductive coupler.

In a further configuration, the device parameter determined according to the series of measurements relates to a resonance frequency of a primary oscillating circuit of a primary device of an inductive coupler. The operating measurement value optionally relates to a primary input current strength of the primary device, and a minimum of the primary input current strength can be determined from the measurement series in order to determine the resonance frequency. The minimum can be determined, for example, by means of a mathematical fit of the measurement series, for example by means of a least-squares method.

In a refinement, the operating parameter is determined as a function of the device parameter using a table (lookup table) or curve stored in a memory, or using a calculation.

In one configuration, the operating parameter is set in a firmware of the device, in a control unit or in a further memory unit, which is optionally comprised by the device.

In a further configuration, the method is carried out when an unknown combination of a primary device is inductively coupled with a secondary device. It may be provided that certain combinations of primary and secondary devices are identified and stored, for example in a memory unit of the primary and/or the secondary device. A combination that has not yet been registered can then be identified by identifying features of the primary and secondary devices.

Further, the method can be carried out repeatedly at predetermined time intervals or upon a request signal. For example, a request signal can be generated automatically or entered by a user. Optionally, a time series of the operating measurement value is recorded and stored. For example, a time evolution of the operating measurement value can be analysed, for example to detect a deterioration of the transmission properties.

A device for inductive transmission of electrical power comprises an oscillating circuit and a control unit. The control unit is configured to activate the device in such a way that:
the oscillating circuit is operated with a measurement activation frequency;
the measurement activation frequency is varied over a specified measuring range;
a series of measurements with an operating measurement value as a function of the measurement activation frequency is recorded;
a device parameter is determined as a function of the measurement series; and
depending on the determined device parameter, at least one operating parameter of the device, optionally an operating parameter for the inductive power transmission, is determined and set.

As already explained above, the operating parameter may relate to different parameters, for example, an operating frequency for an inductive power transmission, optionally an activation frequency for operating the primary oscillating circuit, for example, a starting frequency for the power transmission. The operating parameter can also relate to a minimum activation frequency. It can further relate to at least one threshold value for starting and/or ending the inductive power transmission and/or to a threshold value for foreign object detection.

Optionally, a plurality of operating parameters can be determined and set with the method. The device is designed, optionally, to carry out the method described here. It therefore has the same advantages as the method and can be further developed in an analogous manner as described for the method.

The device may be designed, for example, as a primary device for inductive coupling to a secondary device. The device can further be designed as a system having a primary and a secondary device, which may also be inductively coupled to each other for power transmission.

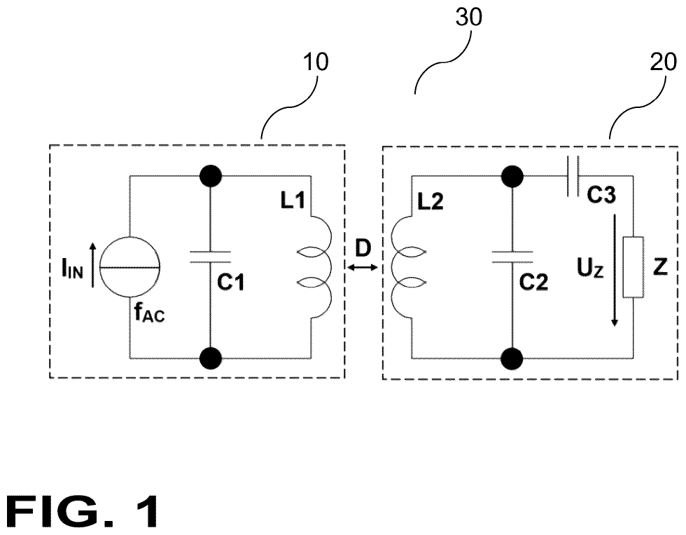

With reference to FIG. 1, a schematic representation of a primary and a secondary oscillating circuit is explained in equivalent circuit diagrams. Optionally, the primary and secondary resonant circuits form an inductive coupler for contactless electrical power transmission from the primary side (transmitter) to the secondary side (receiver).

In the example, the primary oscillating circuit of the primary side 10 is designed as a parallel oscillating circuit. It comprises a capacitor C1 and an inductor L1 connected in parallel. An input current I_{IN} with an excitation frequency f_{AC} is also provided.

In the example, the secondary oscillating circuit 20 has a capacitor C2 and an inductor L2 connected in parallel. Furthermore, a load with an impedance Z is provided via a further capacitor C3 connected in series, across which a voltage U_{Z} is dropped.

The inductors L1, L2 of the primary side 10 and secondary side 20 are arranged at a distance D.

It is assumed that the parallel resonant circuit at resonance—i.e. when it is excited with its characteristic resonance frequency—behaves like an ohmic resistance and that the impedance of the parallel circuit assumes its greatest value at resonance. Accordingly, at resonance, the total current flowing in the circuit is at its lowest.

In order to make a power adjustment for the secondary side on the primary side, optionally due to the device-specific secondary impedance Z, components are typically dimensioned so that they are matched to the inductor L2 or capacitors C2, C3 on the secondary side. In order to obtain specific values for the distance and power range, to obtain optimum energy transmission the activation frequency of the primary oscillating circuit (f_{AC}) is adjusted in such a way that a desired power is transmitted.

In addition to the tolerance ranges for the front coil inductances on the primary and secondary side L1, L2, the tolerances for the parallel and/or series capacitors C1, C2, C3, which also influence the power matching of the oscillating circuits to the secondary impedance Z, must also be taken into account in the manufacture of the oscillating circuits.

Determining device-specific properties of the primary and secondary oscillating circuit can be complicated in this arrangement by the fact that the components are encapsulated in the terminal. Therefore, a measurement procedure is implemented according to the following principle:
firstly, a characteristic resonance frequency of the primary and secondary oscillating circuit is determined. For this purpose, the activation frequency f_{AC} of the primary oscillating circuit is varied and a measurement of the input current I_{IN} into the primary oscillating circuit is evaluated. The output voltage of the secondary oscillating circuit U_{Z} is also taken into account.

A constant distance D between primary 10 and secondary side 20 is assumed, optionally a distance D=0 mm.

During the measurement, no consumer is supplied by the secondary side, i.e. the secondary side is in idle mode.

Furthermore, the primary oscillating circuit 10 is supplied with a maximum DC link voltage, for example with 20 V DC.

Based on the characteristic properties of the primary device 10, the secondary device 20 and/or of the system 30 formed by it, which can be determined in this way, firmware parameters can be adjusted.

Such a parameter may be an activation frequency of the primary oscillating circuit 10, optionally a starting frequency for energy transmission with a secondary side 20. Furthermore, threshold values can be set as parameters, on the basis of which a test is performed with an induced secondary voltage as to whether the energy transmission from the primary 10 to the secondary side 20 should be enabled or aborted or whether a power supply of a consumer connected on the secondary side should be enabled or aborted. Threshold values for foreign object detection can also be set as parameters.

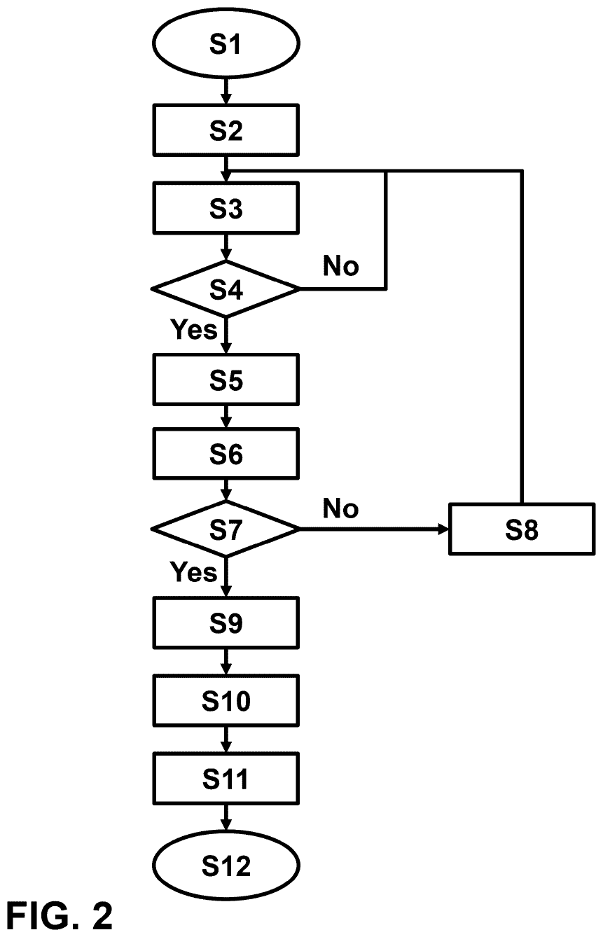

With reference to FIG. 2, a diagram showing the sequence of a program for ,,teaching” the operating parameter is explained. This is based on a system such as the one described above and describes steps in the program flow diagram to determine device-specific properties of the primary and secondary oscillating circuits.

In a first step S1, the teaching process begins with the initialization of the system.

In this example, a current actuation frequency of the primary oscillating circuit is initially set to a specified minimum value, for example at an actuation frequency of 100 kHz.

In the example, the primary oscillating circuit is also supplied with the maximum DC link voltage, for example with 20 V DC.

In addition, a fixed distance D of the primary oscillating circuit from the secondary side is set in the example.

In order to perform measurements on the primary side in the uncoupled state, a specific larger distance is set, in the example approximately D>60 mm; in the example, it is assumed that no inductive power transmission takes place. In order to measure the primary side in the coupled state, a distance D of 0 mm is set, i.e. the secondary side is located essentially on the primary side.

In this example, the measurement is to be performed in the coupled state, i.e. a distance of D=0 mm is set.

In addition, in the example, data transmission between the primary and secondary sides is activated; for example, data transmission can take place via IO-Link.

In the coupled state, it is also provided that the output of the secondary side is active, for example with an output voltage of V_{OUT}=24 V DC.

Predefined values of a lower and an upper activation frequency are set. The minimum and maximum values define a measuring range in which measurements are performed to determine the device-specific properties.

In a further step S2, a minimum value of the activation frequency of the primary oscillating circuit is set; in the example, a value of 120 kHz is set, but other suitable values can also be used.

In a further step S3, the primary oscillating circuit is excited with the set activation frequency. In a further step S4, it is checked whether the excitation has taken place for a defined settling period, wherein, for example, 10 ms can be assumed as the settling period.

In a further step S5, which is carried out optionally after the settling period has elapsed, the current strength that flows into the primary oscillating circuit is detected and, in a further step S6, stored together with the currently set value of the activation frequency in the memory of the primary side.

In a further step S7, it is checked whether the currently set activation frequency corresponds to the predefined maximum activation frequency or whether the measurement has already been carried out over the entire defined measuring range. As long as this is not yet the case, in a further step S8 the activation frequency is increased by a preset or adjustable value of an increment of the activation frequency, for example by an increment of 1 kHz, and the measurement is repeated with the new activation frequency starting from step S3.

When the upper value of the activation frequency, for example 150 kHz is reached, the measurement series thus recorded is evaluated in a further step S9; e.g., the minimum value of the detected current strength is determined for this purpose. In step S10, the corresponding activation frequency is assigned to the specified minimum value of the detected current strength.

In a further step S11, the activation frequency determined in this way, which corresponds optionally to a resonance frequency of the primary oscillating circuit of the device in the given configuration, is used to determine and adjust an operating parameter of the device.

The operating parameter can be, for example, an activation frequency of the primary oscillating circuit, for example, an operating frequency for operation in the coupled system, optionally a starting frequency for an inductive power transmission to a coupled secondary side. Alternatively, or additionally, threshold values for the induced secondary voltage can be defined, on the basis of which an inductive power transmission from the primary to the secondary side is enabled or aborted and/or on the basis of which a power supply to a consumer connected on the secondary side is enabled or interrupted. As an alternative or in addition, threshold values can be determined and set, on the basis of which a foreign object detection is carried out, optionally to detect whether unwanted power is being lost to a metallic foreign object.

The teaching process is terminated in a further step S12. Optionally, the system can then be reverted to an electrical power transmission mode.

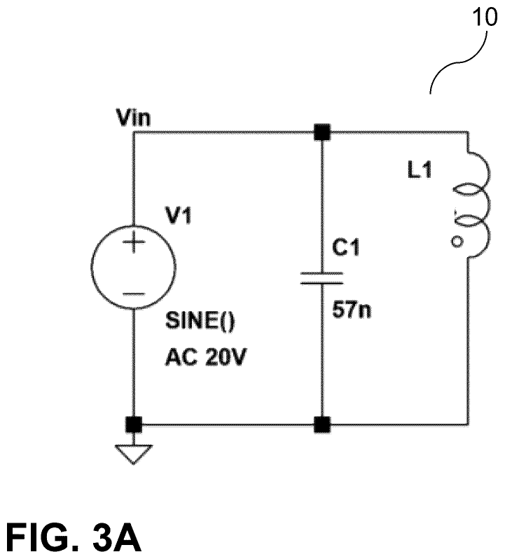

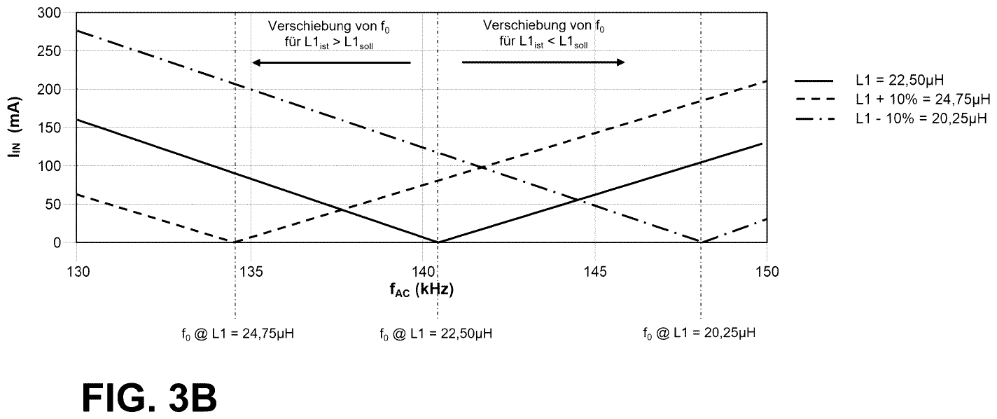

With reference to FIGS. 3A and 3B, an equivalent circuit diagram and simulated measurement data for an uncoupled primary device are explained. This is based on the above explanations and only differences or more precisely presented details will be explained in more detail.

In the case shown in FIG. 3A, the primary device 10 comprises a parallel oscillating circuit in which a coil with an inductance L1 and a capacitor with a capacitance C1 of 57 nF are connected in parallel. In the example, this oscillating circuit is excited with an activation frequency f_{AC}, wherein a sinusoidal activation signal with a voltage of 20 V is applied. For simplification, it is assumed in this case that no secondary side is coupled to the primary side; for example, any secondary side that may be present may be more than 60 mm away from the secondary side.

The measurement on this primary oscillating circuit is carried out in the manner specified above by changing the activation frequency in steps of 1 kHz from 100 kHz to 150 kHz.

In the diagram of FIG. 3B, the curve of the primary-side input current I_{IN} in mA is shown as a function of the activation frequency f_{AC}.

The three curves shown are the results of a simulation with an inductance L1 of 22.50 μH, 20.25 μH and 24.75 μH respectively. This corresponds to an inductance of 22.50 μH plus or minus 10%, which corresponds approximately to a standard manufacturing tolerance for a corresponding component.

The diagram of FIG. 3B shows that the three curves have different minima of the input current I_{IN} as a function of the activation frequency f_{AC}, namely at a lower frequency, the greater the inductance L1. Conversely, the smaller the inductance L1, the higher the frequency of the minimum. The frequency f_{AC} at which the primary-side input current strength I_{IN} reaches its minimum is the resonance frequency of the primary-side oscillating circuit.

Based on these measurement results, an operating parameter for the primary device 10 is then set or stored. For example, an operating frequency or a starting frequency for an inductive power transmission can be set, which is located optionally at the resonance frequency. As an alternative or in addition, further operating parameters can be set as described here, for example threshold values for enabling the supply of a secondary-side load or for foreign object detection.

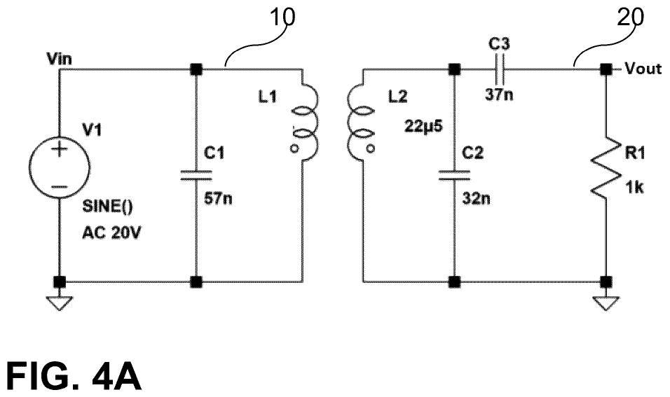

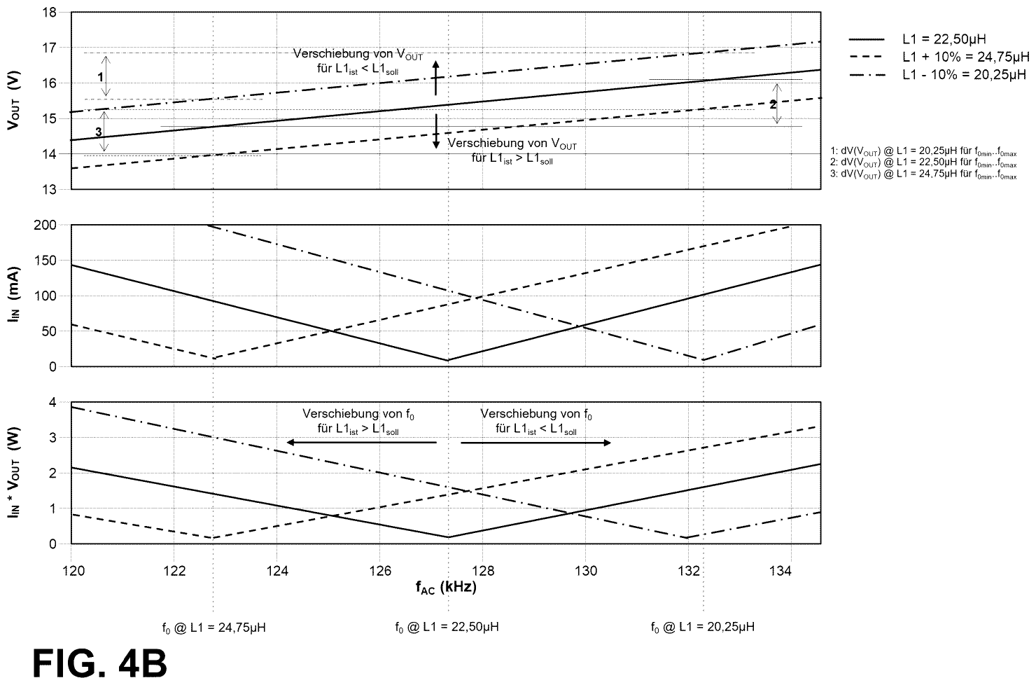

With reference to FIGS. 4A and 4B, an equivalent circuit diagram and simulated measurement data for an unknown primary device which is coupled to a known secondary device are explained. This is based on the above explanations.

In the case shown in FIG. 4A, the primary device 10—similarly to the explanation already given above with reference to FIG. 3A—comprises a parallel oscillating circuit. This comprises a coil with an inductance L1 and a capacitor with a capacitance C1 of 57 nF. In the example, this oscillating circuit is excited with an activation frequency f_{AC}, wherein a sinusoidal activation signal with a voltage of 20 V is applied.

The secondary device 20 also comprises a coil with an inductance L2, which in this example is 22.50 μH, and a capacitor connected in parallel to it with the capacitance C2 of 32 nF. In addition, a further series capacitor C3 with the capacitance 37 nF is provided after the resonant circuit and the secondary oscillating circuit is short-circuited via a resistor R1 of 1 kΩ. The resistor R1 represents in simplified form the complex impedance Z of the equivalent circuit diagram specified in FIG. 1. This allows the (comparative) measurement of the voltage Vout for the different resonant circuit configurations (L+/−10%). A value of R1=1 kΩ corresponds to a good approximation to the real behavior of the device.

For simplification, a distance D of 0 mm is assumed between the primary device 10 and the secondary device 20. Optionally, the value of the distance D=0 mm refers to the distance between the front caps of the couplers encapsulated in the devices 10, 20. The front coils typically have an actual distance of approximately 3 mm to each other.

In the diagrams of FIG. 4B, the curves of the secondary-side output voltage Vₒᵤₜ in V, of the primary-side input current I_{IN} in mA and the product of these two values in W (Watts) are shown as a function of the activation frequency f_{AC}.

The three curves shown are the results of a simulation with an inductance L1 of 22.50 μH, 20.25 μH and 24.75 μH respectively. This corresponds to an inductance of 22.50 μH plus or minus 10%, which corresponds approximately to a standard manufacturing tolerance for a corresponding component.

The diagrams of FIG. 4B show that the three curves have different minima of the input current I_{IN} as a function of the activation frequency f_{AC}, namely at a lower frequency, the greater the inductance L1. The frequency f_{AC} at which the primary-side input current I_{IN} reaches its minimum corresponds to the system-specific resonance frequency in each case.

The curves also show that the trace of the output voltage Vₒᵤₜ shifts downwards with increasing inductance L1. The differences are indicated at the side of the plot.

Based on these measurement results, an operating parameter for the primary device 10 and/or the secondary device 20 is then set or stored. For example, an operating frequency or a starting frequency for an inductive power transmission can be set, which is located optionally at the resonance frequency. As an alternative or in addition, further operating parameters can be set as described here, for example threshold values for enabling the supply of a secondary-side load or for foreign object detection.

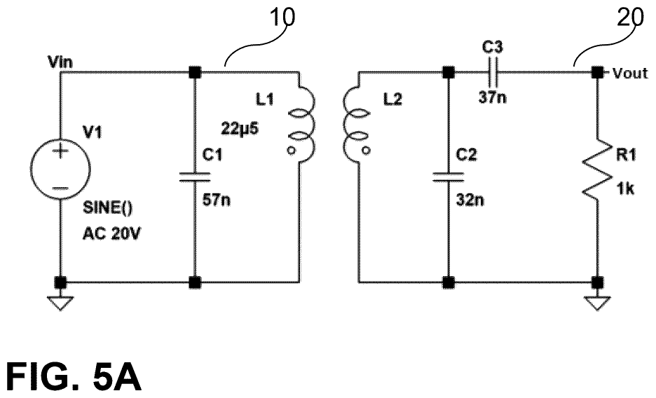

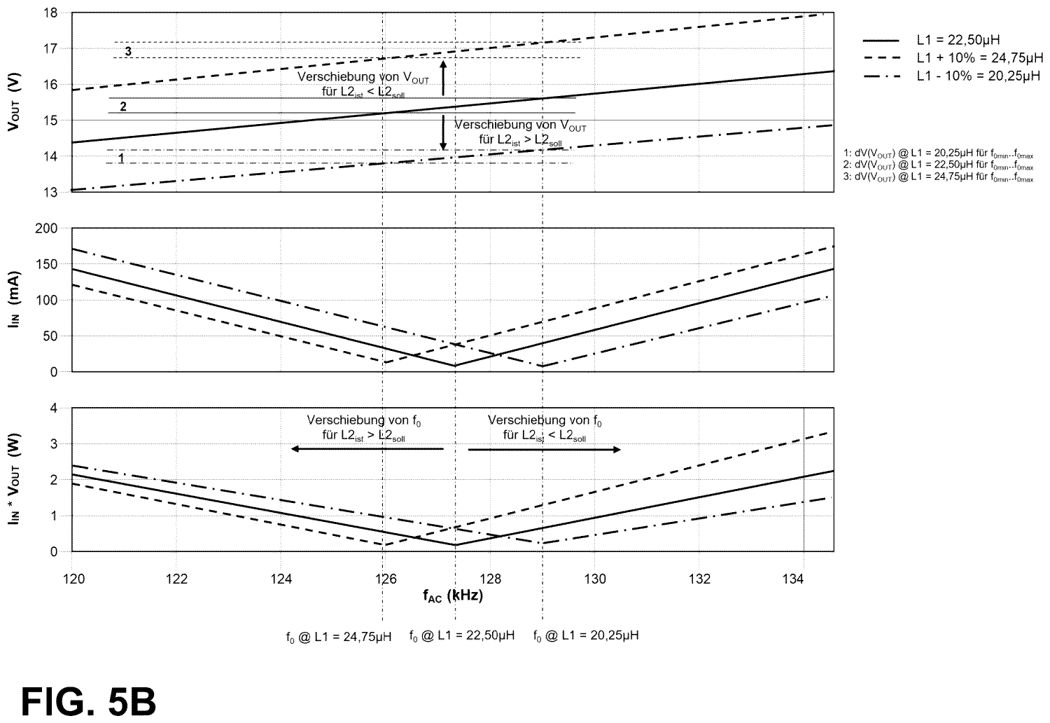

With reference to FIGS. 5A and 5B, an equivalent circuit diagram and simulated measurement data for a known primary device which is coupled to an unknown secondary device are explained. This is based on the above explanations.

In the case shown in FIG. 5A, the primary device 10 comprises a parallel resonant circuit having a coil with an inductance L1 of 22.50 μH and a capacitor with a capacitance C1 of 57 nF. The primary oscillating circuit is excited with an activation frequency f_{AC}, wherein a sinusoidal activation signal with a voltage of 20 V is applied.

The secondary device 20 also comprises a coil with an inductance L2 and a capacitor connected in parallel to it with the capacitance C2 of 32 nF. In addition, a further series capacitor C3 with a capacitance of 37 nF is provided after the resonant circuit and the secondary oscillating circuit is short-circuited via a resistor R1 of 1 kΩ. As already explained above, the resistor R1 represents the complex impedance Z in simplified form.

For simplification, a distance D of 0 mm is assumed between the primary device 10 and the secondary device 20. Here, also, the distance D refers to the distance between the front caps of the encapsulated couplers, so that an actual distance of approximately 3 mm is typically obtained.

In the diagrams of FIG. 5B, the curves of the secondary-side output voltage Vₒᵤₜ in V, of the primary-side input current I_{IN} in mA and the product of these two values in W (Watts) are shown as a function of the activation frequency f_{AC}.

The three curves shown are the results of a simulation with an inductance L2 of 22.50 μH, 20.25 μH and 24.75 μH respectively. This corresponds to an inductance of 22.50 μH plus or minus 10%, which corresponds approximately to a standard manufacturing tolerance for a corresponding component.

The diagrams of FIG. 5B show that the three curves have different minima of the input current I_{IN} as a function of the activation frequency f_{AC}, namely, the lower frequency, the greater the inductance L2. The frequency f_{AC} at which the primary-side input current strength I_{IN} reaches its minimum corresponds to the system-specific resonance frequency.

The curves also show that the trace of the output voltage Vₒᵤₜ shifts upwards with increasing inductance L2. The differences are indicated at the side of the plot.

Based on these measurement results, an operating parameter for the primary device 10 and/or the secondary device 20 is then set or stored. For example, an operating frequency or a starting frequency for an inductive power transmission can be set, which is located optionally at the resonance frequency. As an alternative or in addition, further operating parameters can be set as described here, for example threshold values for enabling the supply of a secondary-side load or for foreign object detection.

In summary, the following cases can be distinguished in the implementation of the disclosure: the properties of a primary oscillating circuit can be determined in an uncoupled state (see FIGS. 3A, 3B), the properties of a primary oscillating circuit can be determined in a coupled state with a known secondary side (see FIGS. 4A, 4B) or the properties of a secondary oscillating circuit can be determined in a coupled state with a known primary side (see FIGS. 5A, 5B). In addition, the properties of an unknown coupler system can be determined in the coupled state (not separately shown). Characteristic parameters for evaluating the oscillating circuit properties are the resonance frequency f₀, the input current I_{IN} into the oscillating circuit of the primary side and/or the output voltage Vₒᵤₜ from the oscillating circuit of the secondary side.

The parameters can be determined under the following test conditions:
In order to determine the characteristic resonance frequency of the primary and secondary oscillating circuits, the activation frequency f_{AC} of the primary oscillating circuit is varied and measurements of the input current I_{IN} into the primary oscillating circuit and the output voltage Vₒᵤₜ of the secondary oscillating circuit are evaluated.
The distance D between the primary and secondary sides is constant (D=0 mm).
There is no power supplied to a consumer connected to the secondary side, i.e. the secondary side is in idle mode.
The primary oscillating circuit is supplied with the maximum DC link voltage, in the example 20 V DC.

### REFERENCES SYMBOLS

10 primary oscillating circuit; primary device; transmitter
20 secondary oscillating circuit; secondary device; receiver
30 system
C1, C2, C3 capacitor
D distance
f_{AC} excitation frequency, measurement activation frequency
I_{IN} input current strength
L1, L2 inductor, front coil inductor
R1 active resistance of the secondary side
U_{Z}, Vₒᵤₜ voltage drop; DC link voltage
Z impedance (secondary side)

What is claimed is:

1. A method for setting at least one operating parameter of a device (10, 20, 30) for inductive transmission of electrical power, the method comprising:
operating at least one oscillating circuit (10) of the device with a measurement activation frequency (f_{AC});
wherein the measurement activation frequency (f_{AC}) is varied over a specified measuring range in such a way that a series of measurements is acquired, wherein the measurement series relates to at least one operating measured value (I_{IN}, Vₒᵤₜ) as a function of the measurement activation frequency;
determining a device parameter as a function of the measurement series; and
determining and setting the operating parameter depending on the determined device parameter;
wherein the operating parameter relates to at least one threshold value for a start and/or ending of the inductive power transmission and/or at least one threshold value for foreign object detection in the inductive power transmission.

2. The method according to claim 1,
wherein:
the device (10) is designed as a primary device (10), which can be operated as a transmitter for inductive power transmission, wherein the primary device (10) is optionally operated in an uncoupled state; or
the device is designed as a system (30) with a primary device (10) and a secondary device (20), which can be operated as a transmitter and receiver for inductive power transmission.

3. The method according to claim 2,
wherein
the oscillating circuit (10) of the device is designed as a primary oscillating circuit of the primary device (10);
wherein the oscillating circuit (10) is optionally operated in an uncoupled state or in a coupled state.

4. The method according to claim 1,
wherein
the operating parameter relates to an operating frequency for an inductive power transmission.

5. The method according to claim 1,
wherein:
the operating measurement value (I_{IN}, Vₒᵤₜ) is an electrical operating measurement value; and
the operating measurement value (I_{IN}) relates optionally to a primary input current strength (I_{IN}) of a primary device of an inductive coupler and/or to a secondary output voltage (Vₒᵤₜ) of a secondary device (20) of an inductive coupler.

6. The method according to claim 1,
wherein
the device parameter determined according to the series of measurements relates to a resonance frequency of a primary oscillating circuit (10) of a primary device of an inductive coupler;
wherein the operating measurement value (I_{IN}, Vₒᵤₜ) optionally relates to a primary input current (I_{IN}) of the primary device and a minimum of the primary input current (I_{IN}) is determined from the measurement series in order to determine the resonance frequency; and
wherein the minimum is optionally determined by means of a mathematical fit to the measurement series.

7. The method according to claim 1,
wherein
the operating parameter is determined as a function of the device parameter using a table or curve stored in a memory or using a calculation.

8. The method according to claim 1,
wherein
the operating parameter is set in a firmware of the device (10, 20, 30), in a control unit or in a further memory unit, which is optionally comprised by the device (10, 30).

9. The method according to claim 1,
wherein
the method is carried out when an unknown combination of a primary device (10) is inductively coupled with a secondary device (20); and/or
the method is carried out repeatedly at specified intervals or upon a request signal, wherein a time series of the operating measurement value is acquired and stored.

10. A device (10, 20, 30) for inductive transmission of electrical power; comprising
an oscillating circuit (10) and a control unit; wherein: the control unit is configured to activate the device (10, 30) in such a way that:
the oscillating circuit (10) is operated with a measurement activation frequency (fAC);
the measurement activation frequency (fAC) is varied over a specified measuring range;
a series of measurements with an operating measurement value as a function of the measurement activation frequency (fAC) is recorded;
a device parameter is determined as a function of the measurement series; and
at least one operating parameter of the device (10, 20, 30) is determined and set depending on the determined device parameter; and
wherein the operating parameter relates to at least one threshold value for a start and/or ending of the inductive power transmission and/or at least one threshold value for foreign object detection in the inductive power transmission.
